(19) United States
(12) Patent Application Publication
(10) Pub. No.: US 2009/0096599 A1
(43) Pub. Date: Apr. 16, 2009

(54) Identification and Monitoring of Vehicle Sensors

(75) Inventor: Mark J. Kranz, Hallsville, TX (US)

Correspondence Address: HOLLAND & HART, LLP, P.O BOX 8749, DENVER, CO, 80201, US

(73) Assignee: Stemco LP, Longview, TX (US)

(21) Appl. No.: 11/872,485

(22) Filed: Oct. 15, 2007

(51) Int. Cl. B60Q 1/00

(52) U.S. Cl. 340/459

(57) ABSTRACT

Systems, methods, and apparatuses are provided for monitoring the status of sensors that sense the parameters of one or more vehicle components. A monitor in a first vehicle receives RF signals from sensors that are located remotely from the monitor. The sensors may be associated with vehicles other than the first vehicle, and it is desired to monitor only the sensor(s) that are also associated with the first vehicle. Sensors may be selected for monitoring by reading a plurality of different sensors and selecting one or more sensors from the plurality of sensors that are associated with the first vehicle and thus are to be monitored Sensors that are to be monitored are selected based on predetermined criteria after it is determined that the first vehicle is in motion. The monitor includes a motion sensor that is operable to determine if the vehicle is in motion.

### FIELD

The present invention is related to wireless identification and monitoring of sensors, and more specifically, to associating a particular sensor, or sensors, a remote monitor, and monitoring of the associated sensor(s).

### BACKGROUND

Vehicle safety and efficiency are concerns for any vehicle operator. Safety is important for the operator of a vehicle, for the passengers in the vehicle, and for others that share the road with the vehicle. Safe vehicle operation also may reduce vehicle repair costs and downtime. Efficiency also is important for the vehicle operator and the vehicle owner. Efficient vehicle operation may reduce operating and maintenance costs associated with a vehicle, thereby improving profit margins for a business that operates vehicles. Components that contribute to both vehicle safety and efficiency include axle components and drive train components. Axle components include wheels, wheel hubs, pneumatic tires, suspension components, braking components, and the like. Drive train components include a vehicle engine and components that transfer power from the engine to the drive wheels of the vehicle.

Proper maintenance of the vehicle is important to safe and efficient operation of the vehicle. Proper maintenance includes proper lubricant fluid levels, proper replacement of fluids, proper tire pressures, and the like. In the case of a pneumatic tire, for example, improper air pressure in the tire can reduce safety due to an increased likelihood of a failure of the tire due to increased heating and/or increased or uneven tread wear. Improper air pressure can also increase costs associated with operating the vehicle due to reduced life of the tire, thereby increasing replacement costs, and also increased rolling friction that reduces fuel economy of the vehicle and increases fuel costs. Similarly, if a lubricant fluid level is low or if the lubricant has become contaminated or broken down, continued operation of the vehicle may result in costly repairs and reduced fuel economy. Tire pressure and lubricating fluid level are but two examples of vehicle components that may influence vehicle safety and efficiency.

Accordingly, an important aspect with respect to operating any vehicle is the proper maintenance of various components to ensure proper vehicle performance. In the case of an entity that operates a number of different vehicles, such as a trucking company, such maintenance is particularly important to ensure that costs associated with vehicle operation are not unnecessarily increased. However, in many cases the volume of maintenance checks and the time required to perform such checks, coupled with shipping and delivery deadline pressures, results in such checks being performed less often than is ideal. Additionally, the value of maintenance checks to confirm proper vehicle conditions offset some of the benefits of properly maintained vehicles due to the costs associated with performing such checks. Furthermore, in many cases a tractor may be coupled to a trailer, further increasing the number of and time required for checking the status of various components.

### SUMMARY

Embodiments disclosed herein provide systems and methods for monitoring the status of sensors that sense the parameters of one or more vehicle components. A monitor in a first vehicle receives RF signals from sensors that are located remotely from the monitor. The sensors may be associated with vehicles other than the first vehicle, and it is desired to monitor only the sensor(s) that are also associated with the first vehicle. Sensors may be selected for monitoring by reading a plurality of different sensors and selecting one or more sensors from the plurality of sensors that are to be monitored. Sensors that are to be monitored are selected based on predetermined criteria after it is determined that the first vehicle is in motion.

In one aspect, an apparatus provided that identifies and monitors one or more sensors associated with the vehicle, comprising (a) a radio frequency (RF) receiver that receives RF signals from one or more sensors; (b) a processing unit operably interconnected to the RF receiver that monitors information related received RF signals from the one or more sensors; (c) a motion sensor operably interconnected to the processing unit that detects motion of the vehicle; (d) the processing unit being operable to receive input from the motion sensor and when motion is detected, monitor the received RF signals, associate one or more sensors with the vehicle based on characteristics of the received RF signals, and monitor a status of an output of the sensor(s) associated with the vehicle. The RF receiver may receive RF signals from a plurality of sensors, with the one or more sensor(s) associated with the vehicle being a subset of the plurality of sensors. In an embodiment, the received RF signals include information on a value of an output of the sensor and limits of acceptable values, and the processing unit is further operable to generate an alarm when the value of the output is outside of the limits of acceptable values. The motion sensor may be an accelerometer, and in an embodiment is a three-axis accelerometer where the processing unit computes average acceleration on each axis, records deviations from the average, detects acceleration events when deviations are present for a predetermined time, and detects motion when acceleration events remain present for a predetermined time. The monitor may associate a sensor with the vehicle when, after the motion sensor detects motion, an RF signal from the particular sensor is received at least a predetermined number of times. The monitor may discontinue monitoring an associated sensor when the RF receiver no longer receives RF signals from the associated sensor. The remote sensor(s) may be associated with a vehicle tire, vehicle hub, and/or vehicle axle, for example. In another embodiment, the apparatus further comprises a telemetry unit operably interconnected to the processing unit and operable to communicate a status of the one or more identified sensors to a remote system that monitors a fleet of vehicles.

Another aspect of the present disclosure provides a method for associating a sensor with a monitor. The method of this aspect comprises the steps of (a) determining whether the monitor is in motion; (b) detecting radio frequency (RF) signals from one or more sensors; (c) monitoring characteristics of the detected RF signals; (d) determining that RF signals from a first sensor meet predefined characteristics when it is determined that the monitor is in motion; and (e) associating the first sensor with the monitor. The method of this aspect may further comprise determining that RF signals from a second sensor meet the predefined characteristics when the monitor is in motion, the second sensor different from the first sensor; and associating the remote sensor with the monitor. The method may also further comprise the steps of determining that the OF signals from the first sensor no longer meet the predefined characteristics; and disassociating the first sensor with the monitor. The value of an output of the first sensor may be monitored and an alarm generated when the value is outside of a predefined range.

In still another aspect, the present disclosure provides a system for monitoring a property of a vehicle. The system of this aspect comprises (a) at least one sensor unit associated with the vehicle axle, the sensor unit comprising: (i) a sensor that is operably interconnected with the vehicle axle and that outputs a value corresponding to the sensed parameter of the vehicle; (ii) a radio frequency (RF) transmitter operably interconnected to the sensor that transmits the output of the sensor; and (b) a monitor, comprising: (i) a RF receiver that receives RF signals from one or more sensor units; (ii) a processing unit operably interconnected to the RF receiver that monitors information related received RF signals from the one or more sensor units; and (iii) a motion sensor operably interconnected to the processing unit that detects motion of the monitor. The processing unit is operable to receive input from the motion sensor and when motion is sensed, monitor the received RF signals, associate one or more sensor(s) with the monitor based on characteristics of the received RF signals, and monitor a status of the parameter monitored by each of the associated sensor(s). The RF receiver may receive RF signals from a plurality of sensors, and the one or more associated sensor(s) are a subset of the plurality of sensors. The processing unit may generate an alarm when the monitored property is outside of a predetermined range. The system of this aspect, in an embodiment, further comprises a telemetry unit operably interconnected to the monitor and operable to communicate a status of the associated sensor(s) to a remote system that monitors a fleet of vehicles.

### BRIEF DESCRIPTION OF THE DRAWINGS

FIG. 1 is a perspective view of a tractor and trailer of one embodiment;

FIG. 2 is a block diagram illustration of a sensor unit of an embodiment;

FIG. 3 is a block diagram of an in-cab monitor of an embodiment;

FIG. 4 is a block diagram illustration of a number of sensor units and an in-cab monitor for an embodiment;

FIG. 5 is a flow chart diagram illustrating the operational steps for associating one or more sensors with a monitor for an embodiment;

FIG. 6 is a flow chart diagram illustrating the operational steps for sensor monitoring and alarm generation for an embodiment;

FIG. 7 is a block diagram illustration of a memory storage configuration for an embodiment; and

FIG. 8 is a block diagram illustration of a number of sensor units, an in-cab monitor, and a telemetry unit for an embodiment.

### DETAILED DESCRIPTION

For a more complete understanding of this invention, reference is now made to the following detailed description of several embodiments as illustrated in the drawing figures, in which like numbers represent the same or similar elements. Various embodiments are described herein, with specific examples provided in many instances to serve to illustrate and discuss various concepts included in the present disclosure. The specific embodiments and examples provided are not necessarily to be construed as preferred or advantageous over other embodiments and/or examples.

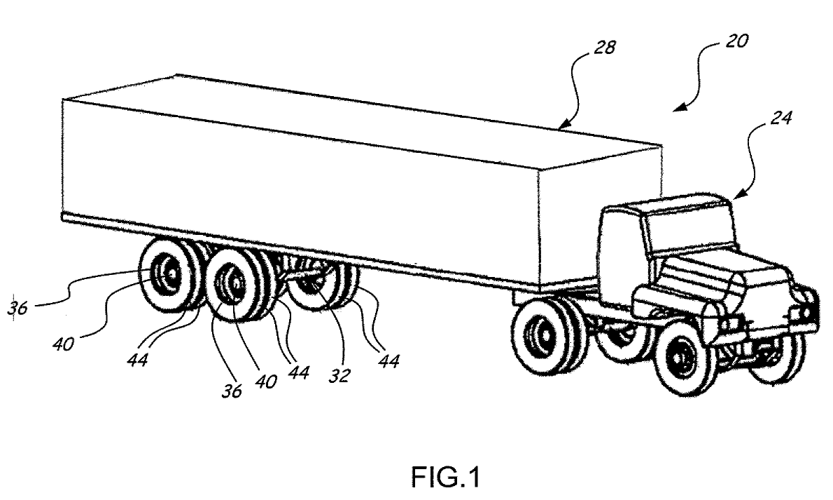

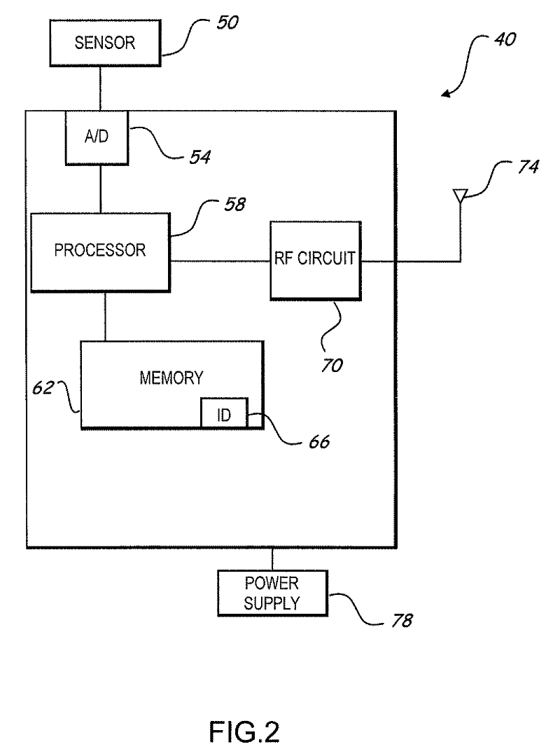

With reference to FIG. 1, an application of an exemplary embodiment is described with respect to a heavy truck 20 having a tractor 24 and trailer 28. The trailer 28 is illustrated in FIG. 1 as a heavy duty trailer and, as is typical of such trailers, includes two axles 32, each of which having dual wheels 36 on each side. However, as will be readily apparent to one skilled in the art, trailer 28 could be a single axle trailer, and axles may have single versus dual wheels. Each set of dual wheels 36, in this embodiment, include a pressure sensor unit 40, that is interconnected with each pneumatic tire 44 on each set of dual wheels 36. An exemplary pressure sensor unit 40 will be described in further detail for an embodiment with respect to FIG. 2. The pressure sensor unit 40, in some embodiments, detects the tire pressure for tires 44. Pressure sensor unit 40 also includes a radio frequency transceiver that receives and transmits radio frequency signals that include information including the sensed tire pressure for each of the tires 44 to which the pressure sensor unit 40 is connected. The trailer 28 may include additional, or other, sensors than tire pressure sensor units 40. Examples of other sensors include sensors that monitor the lubricant within wheel hubs, hobodometers that monitor the distance the vehicle has traveled, weight sensors, asset or vehicle identification sensors, and brake fluid sensors, to name a few. The following discussion uses tire pressure sensor units 40 when describing several various embodiments, however, it will be understood that the present disclosure also is applicable to other sensors in addition to, or instead of, pressure sensor units. As such, the terms “sensor” and “device” are used interchangeably to generally refer to any such sensor. Furthermore, it will be understood that the devices, systems, and methods described herein are also applicable to applications other than heavy trucks, such as passenger vehicles, rail vehicles, marine vessels, aircraft, and any other application where one or more components are desired to be monitored by a monitor that is located remotely from component(s) that are not necessarily permanently associated with the monitor. The term “vehicle” is used generally to refer to any such vehicle and combinations such as a tractor and trailer.

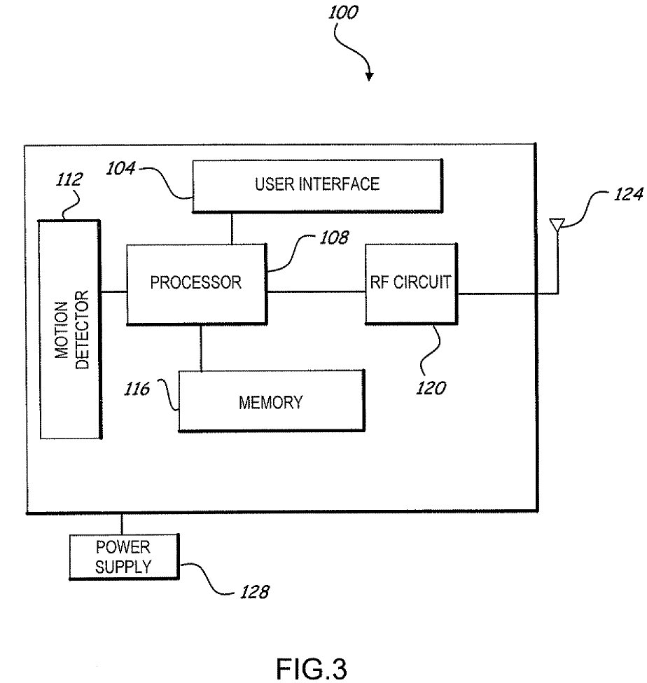

Within the tractor 24, in this embodiment is a monitor (not shown), an embodiment of which will be described in additional detail with respect to FIG. 3. The monitor detects sensor(s) 40 that are associated with the trailer 28, monitors the status of the sensor(s) 40, and generates an alarm if any of the sensor(s) 40 transmit an RF signal that includes information indicative of a sensed parameter that is out-of-limit. In many instances, the tractor 24 may be attached to one of a number of different trailers 28. Such a situation is common in fleet operations where a plurality of trailers 28 may be connected to a plurality of tractors 24. The tractor 24 may hook up to a trailer 28 that is in relatively close proximity to one or more other trailers 28. Each trailer 28 includes one or more sensors 40, and the monitor within the tractor 24, receives RF signals from sensor(s) 40 that are attached to the trailer 28 to which the tractor 24 is hooked up to, as well as from sensor(s) 40 of other trailers to which the tractor 24 is not hooked up. In such a case, the monitor needs to determine which of the several sensors are associated with the hooked up trailer 28. Using the technology of the present disclosure as explained herein, the monitor may determine that the tractor 24 is in motion. The monitor identifies the sensors 40 by receiving RF signals from the sensors 40, and identifies which of the sensors 40 are moving along with the tractor 24. Any sensors 40 that meet a set of predetermined criteria are deemed to be associated with the monitor, and the monitor commences monitoring the status of the identified sensor(s) 40. When the tractor 24 unhooks a trailer 28, and hooks up to a different trailer 28, the monitor again determines which sensors 40 are moving with the tractor 24 and are thus associated with the newly attached trailer 28. When the monitor determines that a sensor 40 is moving with the tractor, and should be monitored, the sensor is referred to as being “bound” to the monitor. As used herein, the term “binding” refers to the process for determining whether a sensor should be monitored by the monitor, and the term “bound” refers to a sensor that has been identified by the monitor as a sensor that is to be monitored.

A block diagram illustration of a pressure sensor unit 40, for an exemplary embodiment, is illustrated in FIG. 2. As discussed above, other sensors may be used in addition to, or instead of, pressure sensors, with all such types of sensors being referred to generically as “sensors” or “sensor units.” In this embodiment, a pressure sensor 50 is connected through an analog-to-digital (A/D) converter 54 to a processor 58. The pressure sensor 50 may be coupled to each pneumatic tire associated with wheels on a trailer axle through any of a number of available techniques. In one embodiment, the pressure sensor 50 is connected through air lines to a valve stem that is associated with each tire. In other embodiments, the pressure sensor 50 may include individual sensors that are located within a pneumatic tire, and wirelessly communicate pressure information to processor 58. The pressure sensor unit 40, in the embodiment of FIG. 2, includes a pressure sensor 50 for each tire, which is calibrated to provide an output that corresponds to the air pressure in each tire. The pressure sensor 50 may be, for example, a pressure transducer. The output from the pressure sensor 50 is provided to the AID converter 54, where the output is converted to a digital signal that is provided to the processor 58. The processor 58 is interconnected with a memory 62, that may include operating instructions for the processor 58, and information related to the pressure sensor 50 such as high/low sensor output limits, information related to sensor calibration, and a unique identification 66 for the pressure sensor unit 40. The processor 58 is interconnected also with an RF circuit 70, that transmits and receives RF signals through antenna 74. A power supply 78 provides power to each of the components of the pressure sensor unit 40, and in one embodiment is a battery that is included within a housing of the pressure sensor unit 40. The power supply 78 also may include a replaceable power source, and/or rechargeable power source. The RF circuit 70 of the pressure sensor unit 40, in an embodiment, is an active transponder that receives an interrogation signal, and in response thereto, transmits a response signal that includes the pressure sensor unit 40's unique identification 66, and information related to the current output of the pressure sensor 50. The RF circuit 70, in some embodiments, may include a passive transponder that uses inductive coupling between an interrogator and the RF circuit to power the pressure sensor unit 40 and transmit the information to the interrogator. In some passive transponder embodiments, a power supply 78 may be eliminated. RF circuit 70 may be a single transceiver circuit, or separate transmit and receive circuits.

With reference now to FIG. 3, a monitor 100 of an exemplary embodiment is described. As discussed above, the monitor 100 may be located within the cab of the tractor 24. Monitor 100 detects and monitors any sensors, such as pressure sensor unit 40, that are associated with the trailer 28 attached to the tractor 24. The monitor 100, in this embodiment, includes a user interface 104 that may provide an indication to a user or vehicle operator relating to the sensor(s). The user interface 104 is interconnected with a processor 108, which in turn in interconnected with a motion detector 112, a memory 116, an RF circuit 120. The RF circuit 120 is coupled to an antenna 124. A power supply 128 provides power to the components of the monitor 100.

With continuing reference to FIG. 3, the user interface 104, in one embodiment, includes a visual indicator that indicates a current condition of the monitor 100 and any sensors that are bound to the monitor 100. For example, the visual indicator may include one or more light emitting diodes (LEDs), with the LEDs illuminated in different states depending upon whether any sensors are bound to the monitor 100, and whether any bound sensors are indicating a sensed parameter is out-of-limit for the parameter. In the event that the sensed parameter is out-of-limit for one or more sensors, the monitor 100 may generate an alarm through the user interface 104. Such an alarm may be a visual and/or audio type of alarm that is likely to catch the attention of the operator of the vehicle. In one embodiment, the visual indicator includes two LEDs, a power-on/status LED, and a warning LED. The power-on/status LED, in this embodiment, is activated to emit a blue output when power is applied to the monitor 100. The output of the power-on/status LED is changed to aqua when motion is detected at the monitor 100. When the monitor 100 has bound at least one sensor, the power-on/status LED is activated to emit a green output, and when the monitor detects motion and has one or more bound devices, the power-on/status LED is activated to emit an orange color. The second LED in this embodiment is a warning LED, that is activated to emit a blinking red output when a monitored device reports a sensor output that is out-of-limit and the monitor 100 is not detecting motion. If the monitor 100 does detect motion and the sensor output is out-of-limit, the warning LED is activated to blink with a magenta output, In such a manner, a vehicle operator may quickly determine the status of a monitor 100 by observing the status of the visual indicators of the user interface 104. As will be understood, the user interface 104 may include any of a number of audio and/or visual indicators to communicate status of the monitor 100, and that the above example is provided for the purposes of example and discussion.

In the event of an alarm, i.e. a sensor is detecting an out-of-limit condition, the vehicle operator may take actions to correct the problem. For example, if the monitor 100 is bound to sensors that monitor tire pressure (i.e., pressure sensor unit 40), an alarm indicates tire pressure in one or more monitored tires is low. The vehicle operator may have air added to the tire in order to bring the tire pressure to the desired level. In other embodiments, the sensor may provide more than one different level of warning, such as an indication that a monitored parameter is at a warning level, or at a critical level, and a vehicle operator can take necessary action based on the level of warning indicated. The user interface 104 also may include input devices that allow a vehicle operator to provide input to the monitor 100, such as, for example, a button used to silence an audio alarm, and/or to reset the monitor 100.

With continuing reference to FIG. 3, the processor 108 performs processing tasks based on signals that are received from one or more other components, and generates output signals to one or more other components. As illustrated in FIG. 3, the processor 108 receives output from a motion detector 112. In one embodiment, the motion detector 112 includes an accelerometer, and when the accelerometer detects acceleration, a signal is output to the processor 108 that indicates the vehicle is in motion. The motion detector 112, in this embodiment, includes a signal processing module that receives the output from the accelerometer and analyzes the output to determine that motion is detected. In other embodiments, the processor 108 receives the output of the accelerometer and analyzes the output to determine that motion is detected. The accelerometer, in an embodiment, is a three-axis accelerometer, that provides an output that corresponds to the magnitude of acceleration detected on each axis. In this embodiment, the average acceleration on each axis is computed. The average acceleration may be computed by any number of methods, and in one embodiment the average acceleration is computed based on an average value of a number of samples taken periodically for each axis. For example, the processor 108, or signal processing module within the motion detector, may sample the accelerometer output once every 464 milliseconds, and the average of 16 samples is computed to determine average acceleration. After an average acceleration is computed, deviations from the average are recorded. Deviations from the average may be recorded as acceleration events with a predefined magnitude above the average acceleration for a period of time, such as, for example, acceleration magnitudes of 0.3 g above the average that last for at least three seconds. The deviations from the average acceleration are monitored, and when a deviation is present for more than a predetermined time period, motion is declared. For example, if a deviation is present for more than 10 seconds, motion is declared. In one embodiment, the processor 108, or signal processing module, stores different motion signatures in a memory 116. For example, a stationary signature, an idling signature, and a motion signature are stored in the memory 116, and motion is declared when the output from the accelerometer matches the motion signature. While a three-axis accelerometer is described, it will be understood that other motion detectors may be used, including, for example, a positioning system, such as GPS, that is monitored to detect motion or changing location/coordinates, or a circuit that is connected to another component within the vehicle that reports motion. In other embodiments, the motion detector is located remotely from the monitor 100, such as in another sensor associated with a vehicle. For example, an electronic hubodometer may include a motion detector, and RF communications from such a hubodometer may include an indication that the sensor is in motion. If a monitor 100 receives a predefined number of RF communications from such a sensor while that sensor is in motion, the sensor may be assumed to be moving along with the monitor, and thus bound to the monitor. Furthermore, while a three-axis accelerometer is described in the above examples, other accelerometers may be used, such as a single-axis or dual-axis accelerometer. In the case of a three-axis accelerometer, the monitor 100 may be mounted in any orientation within the vehicle cab, while accelerometers with fewer axes may require installation in a particular orientation.

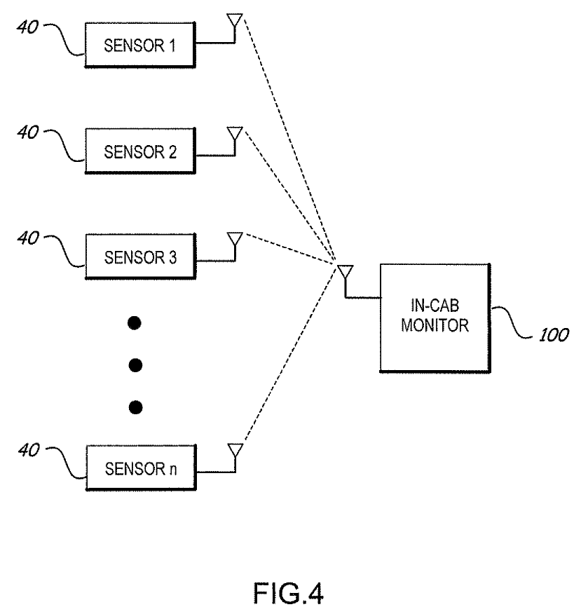

Processor 108 also performs operations to generate read requests of sensors through RF circuit 120 and antenna 124. In one embodiment, the RF circuit 120 and antenna 124 include an interrogator to interrogate an RFID tag within the sensor(s). Such an RFID system may include active, passive, and/or semi-passive RFID interrogators and transponders. With reference to FIGS. 3 and 4, the monitor 100, in response to an interrogation, receives signals from a plurality of sensors 40. When the RF circuit 120 reports receiving a response from a sensor 40, the processor 108 receives the information included in the response and stores associated information in memory 116. The processor 108 may store information from a plurality of sensors 40, and when motion is detected, the processor 108 monitors which of the stored sensors fade from view. Any sensor(s) 40 that remain in view are considered to be bound to the monitor 100, and information related to the bound sensor(s) is written to memory 116. In some embodiments, the memory 116 includes non-volatile memory such that, when the monitor 100 is powered down and up, the same sensor(s) are bound to the monitor 100, and the output thereof is monitored. If the information relating to bound sensor(s) is written to volatile memory, the binding operations are repeated. If the RF circuit 120 discontinues receiving signals from one or more of the bound sensorts) when a signal is no longer received from the sensor.

With reference again to FIG. 3, a power supply 128 provides power to the monitor 100. The power supply 128 may be a self-contained power supply, such as a battery. The power supply 128 may also be interconnected to vehicle power, such as through a power outlet of the vehicle. In one embodiment, the monitor 100 is installed in the vehicle as an aftermarket installation that may be secured within the cab and connected to a power outlet that provides power to the monitor 100. For example, the monitor 100 may be secured to the vehicle dashboard using a hook-and-loop type material and connected to a vehicle lighter that provides power. In such a manner, the monitor 100 may be installed with relative ease and at a location desired by the vehicle operator that is convenient to view or otherwise access the user interface 104. Any sensors that are associated with the vehicle may then be monitored, and the safety and efficiency of the vehicle enhanced due to early notification and correction of any problems that are indicated by the sensors and communicated to the operator through the monitor 100. A monitor 100 may also be installed in a vehicle as original equipment, or installed in a vehicle in a more permanent fashion in an instrument panel of the vehicle.

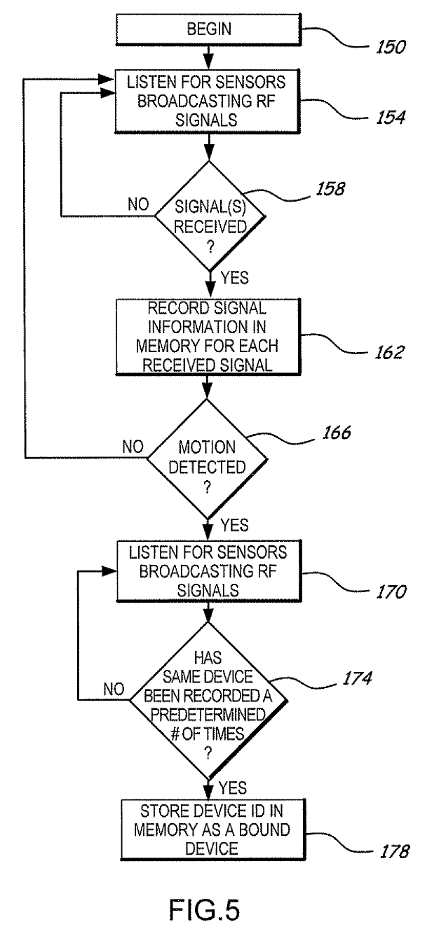

Referring now to FIG. 5, the operational steps for binding sensor(s) are described for an exemplary embodiment. This embodiment begins at block 150, when the monitor may be powered up, or when the monitor otherwise seeks to bind sensors. At block 154, the monitor listens for sensors broadcasting RF signals. The monitor may have a limited field of view or reception range to avoid picking up RF signals that are clearly not related to the attached trailer. The sensors may periodically transmit RF signals, or may transmit RF signals in response to an interrogation signal generated by the monitor. At block 158, it is determined if any RF signals are received. If no signals are received, the operations beginning at block 154 are performed until at least one sensor is identified. If signals are detected, information from the signal is recorded in memory for each signal that is received, as indicated at block 162. At block 166, it is determined if motion is detected. If motion is not detected at block 166, the operations beginning at block 154 continue to be performed to identify any new sensor(s) that may come on-line while the vehicle is stationary. If motion is detected, the monitor listens for sensors broadcasting RF signals, according to block 170. At block 174, it is determined if the same device has been previously recorded a predetermined number of times. If not, the operations of block 170 are performed. If a device has been recorded a predetermined number of times, the identification of the device is stored in memory to indicate that the device is a bound device according to block 178. In one embodiment, if a device is read six times once motion is detected, the monitor considers the device bound. For increased accuracy, in one embodiment, the monitor does not consider a device bound until when 65 seconds has elapsed since the initial binding event. In some embodiments, the monitor performs the operations of FIG. 5 continuously as long as power is present at the monitor, and binds any sensors that meet the binding criteria. In one embodiment, a monitor may bind up to 40 sensors, storing device IDs and related information for each of the bound sensors. The device ID(s), in various embodiments, are stored in non-volatile memory of the monitor such that the device remains bound in the event that the monitor is powered down and back up. For example, a tractor may connect to a trailer and a monitor in the cab of the tractor may bind to sensors on the trailer. When the tractor-trailer travels over the road en-route to a destination, the sensors will be bound to the monitor. In the event that the tractor is powered off, when the tractor is re-started, the sensors on the trailer are treated as bound sensors, and any appropriate alarm generated by the monitor in the event that a sensor detects an out-of-limit condition. The vehicle operator may then take any necessary corrective action prior to beginning travel.

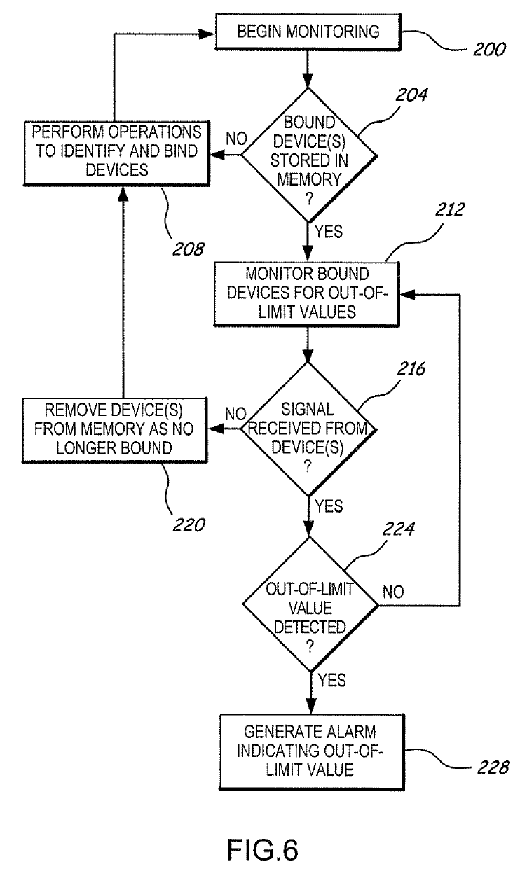

With reference now to FIG. 6, the operational steps for monitoring of a bound sensor are described for an exemplary embodiment. Monitoring begins according to block 200. Such monitoring may be initiated when the monitor binds any devices, is powered up, or reset. At block 204, it is determined whether any bound devices are stored in memory. Such bound devices may be stored in a non-volatile memory, such as an EEPROM or flash memory, within the monitor. If no bound devices are stored in memory, the operations described with respect to FIG. 5 are performed to identify and bind any devices that are associated with the monitor, as indicated at block 208, and the operations associated with block 200 are performed. The monitor also may begin monitoring any/all sensors in its field of view prior to binding any sensors. If one or more bound devices are stored in memory, the bound device(s) are monitored for out-of-limit values, as noted at block 212. The monitoring is performed by receiving RF signals from the bound device(s), the signals including information related to the current status of the sensor. If no signals are received, the device(s) that are stored in memory are removed from memory as no longer bound to the monitor, according to block 220, and the operations of block 208 are then performed. Such a situation may occur, for example, when a tractor disconnects from a trailer and travels away from the disconnected trailer such that the sensors associated with the trailer are out of range. If signals are received from bound devices at block 216, it is determined if the signals received indicate that the bound device has an out-of-limit value, as indicated at block 224. As mentioned above, sensors such as a tire pressure monitor transmit an RF signal that include information including the value of a sensor output along with limits for the sensor output. Such limits may be programmed into the sensor when the sensor is installed on a particular vehicle, such that limits may be different for different sensors. As the sensor transmits these limits along with the value of the sensor output, the monitor makes the out-of-limit evaluation based on the RF signal from the device. If an out-of-limit value is detected at block 224, the monitor generates an alarm indicating that a bound device has an out-of-limit value, as indicated at block 228. An operator of the vehicle may then take appropriate corrective action.

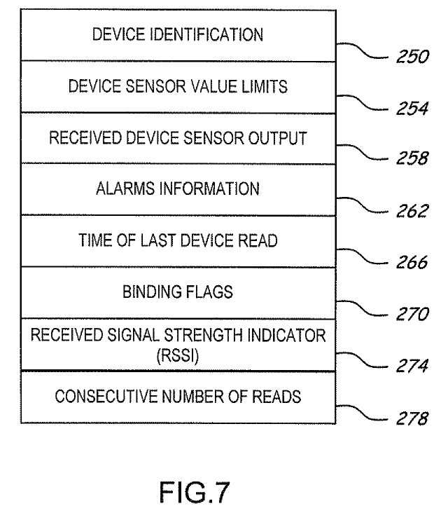

As discussed above in relation to FIG. 2, sensors include an RF circuit 70 that transmits an RF signal that includes, for example, information related to the status of the sensor, current value of the sensor output, limits for sensor values, and other information. As will be understood, the RF circuit 70 may transmit more, less, or different information. The monitor receives this information, and, in an embodiment, stores the information in memory. With reference now to FIG. 7, the storage of information from sensors in memory locations is described for an exemplary embodiment. In this embodiment, the monitor stores a number of different information fields in memory. The information fields include a device identification 250, that in an embodiment is a 32 bit identification code that is a unique code for each sensor. In such a manner, the monitor can identify each sensor, and any further information relative to a particular sensor may be stored in memory associated with the device identification 250. In this embodiment, device sensor value limits 254 are also received in the RF signals transmitted by a sensor, as mentioned above, and stored in memory. For example, a sensor may be a pneumatic tire pressure sensor, which transmits sensor value limits that correspond to a low tire pressure. More specifically, a tire pressure sensor may be mounted to each pneumatic tire on a set of dual wheels where each tire is to be inflated to 110 pounds per square inch (PSI) (758 kPa). The tire pressure sensor may be programmed to have a low value limit of 100 PSI (690 kPa). The pressure sensor transmits this low value limit in the RF transmission that is received by the monitor. Other types of sensors may have both high value limits and low value limits, while some farther types of sensors may have only high value limits. In any event, the limit values for such sensors are transmitted in a similar manner, and stored in the monitor as device sensor value limits 254. In such a manner, the monitor may receive information from a number of different types of sensors without having to have limits for each different type of sensor programmed therein. Also, in many cases limits on sensor values may be dependent upon a particular configuration and associated equipment for the particular trailer on which the sensor is installed, and such information may be programmed into the sensor without having to also program this information in the monitor. In other embodiments, however, the monitor may be programmed with limits. Furthermore, in other embodiments, the sensor may be programmed to simply transmit a notification that a value for the sensed parameter is outside of a value limit, such as an error or warning flag, which the monitor reads to generate an alarm. With continued reference to the embodiment of FIG. 7, received device sensor output 258 corresponds to the value(s) of sensor output that are transmitted by the sensor to the monitor. Continuing with the tire pressure sensor example, the values of the sensor output correspond to the tire pressure in each of the inner and outer tires. In the event that one of the sensor values is outside of the value limits, the monitor generates an alarm. Alarms information 262 corresponds to information related to an alarm. In one embodiment, the alarm information is a byte of data stored in memory that indicates the presence of an alarm based on the value of the byte. The alarms information 262 may include other information such as a flag that is set in the event that a sensor value is outside of a value limit. Time of the last read of the device 266 includes information related to when the last successful read of the device occurred. In one embodiment, the time is stored in an hours-minutes-seconds format that corresponds to a clock maintained by the monitor. This information is used, in some embodiments as described above, to determine when and whether to treat a device as being bound. Binding flags 270 correspond to data indicative that the device is bound to the monitor or not. If a binding flag is set, this indicates that the device is bound to the monitor. Received signal strength indicator (RSSI) 274 relates to the signal strength of the signal from the sensor as received at the monitor. RSSI measurements are well known, and are a measure of magnitude of signal at a receiver. The RSSI 274 may be used, in some embodiments, to determine signals that fade when motion is detected at the monitor. Finally, consecutive number of reads 278 includes information related to the number of times this sensor has been read, and is a counter that is incremented each time the sensor is read. The consecutive number of reads 278 is used in some embodiments to determine when to bind a sensor to the monitor, as discussed above.

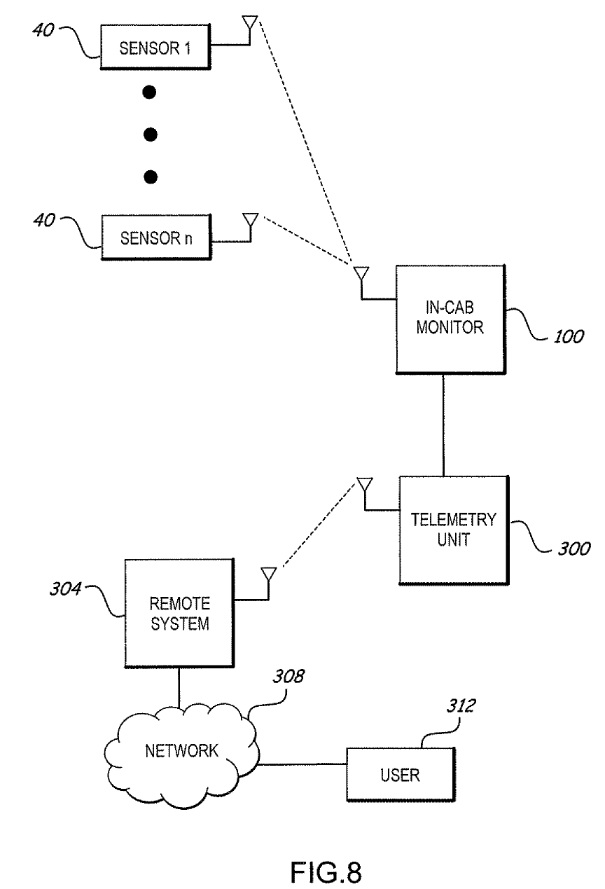

With reference now to FIG. 8, another exemplary embodiment of the present disclosure is now described. This embodiment utilizes an in-cab monitor 100, and sensors 40, similarly as described above, and also a telemetry unit 300 that is interconnected with the monitor 100. The telemetry unit 300, in an embodiment, is installed in a vehicle such as a tractor, and reports information related to the vehicle to a remote system 304 through wireless communications. For example, a telemetry unit 300 may be installed in a tractor, and include a positioning system and cellular communications system. The telemetry unit 300 may periodically report the position of the tractor to the remote system 304 using the cellular communications system. A telemetry unit 300 may also be interconnected with one or more other vehicle systems, such as systems that monitor and report operating parameters of the vehicle, such as speed, miles traveled, and/or vehicle engine operating parameters. The monitor 100 may be interconnected with the telemetry unit 300, which then relays sensor 40 information to the remote system 304. The remote system 304, in this embodiment, is interconnected to a network 308 and a user 312. In such a manner, the user 312, such as a fleet maintenance manager, may access the remote system 304 and determine the status of the various fleet vehicles and sensors 40. The user 304 may schedule maintenance based on such information, and/or track trends associated with each vehicle, For example, if a sensor 40 that includes a pressure sensor periodically reports a low pressure warning on a number of occasions after air has been added to the tire, this may indicate that the associated tire has a slow leak, and should be repaired or replaced.

Those of skill in the art will readily understand that information and signals may be represented using any of a variety of different technologies and techniques. For example, data, instructions, commands, information, and signals that may be referenced throughout the above description may be represented by voltages, currents, electromagnetic waves, magnetic fields or particles, optical fields or particles, or any combination thereof. Those of skill will further appreciate that the various illustrative logical blocks, modules, circuits, and operational steps described in connection with the embodiments disclosed herein may be implemented as electronic hardware, computer software, firmware, or combinations thereof. To clearly illustrate this interchangeability, various illustrative components, blocks, modules, circuits, and steps have been described above generally in terms of their functionality. Whether such functionality is implemented as hardware, software, and/or firmware depends upon the particular application and design constraints imposed on the overall system. Skilled artisans may implement the described functionality in varying ways for each particular application, but such implementation decisions should not be interpreted as causing a departure from the scope of the present invention. Furthermore, the various operational steps as described above are illustrative of some embodiments, and described operations may be performed in sequences other than those described, and various operations may be combined with other operations, or divided into separate operations.

For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media.

The previous description of the disclosed embodiments is provided to enable a person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus that identifies and monitors one or more sensors associated with a vehicle, comprising:
a radio frequency (RF) receiver that receives RF signals from one or more sensors;
a processing unit operably interconnected to the RF receiver that monitors information related to received RF signals from the one or more sensors; and
a motion sensor operably interconnected to the processing unit that detects motion of the vehicle;
the processing unit being operable to receive input from the motion sensor and when vehicle motion is detected, monitor the received RF signals to associate the one or more sensors with the vehicle based on characteristics of the received RE signals, and monitor an output of the one or more sensors associated with the vehicle.

2. The apparatus, as claimed in claim 1, wherein the RF receiver receives RF signals from a plurality of sensors, and the one or more sensor(s) associated with the vehicle are a subset of the plurality of sensors.

3. The apparatus, as claimed in claim 1, wherein the received RF signals include information on a value of an output of the sensor and limits of acceptable values, and the processing unit is further operable to generate an alarm when the value of the output is outside of the limits of acceptable values.

4. The apparatus, as claimed in claim 1, wherein the motion sensor is a three-axis accelerometer.

5. The apparatus, as claimed in claim 4, wherein the processing unit receives input from the motion sensor and computes average acceleration on each axis, records deviations from the average, detects acceleration events when deviations are present for a predetermined time, and detects motion when acceleration events remain present for a predetermined time.

6. The apparatus, as claimed in claim 1, wherein when the processing unit receives an indication of vehicle motion, the received RF signals are monitored and a first sensor is associated with an RF signal from the first sensor is received at least a predetermined number of times.

7. The apparatus, as claimed in claim 1, wherein when the processing unit receives an indication of vehicle motion, the received RF signals are monitored and a first sensor is associated with the vehicle when the RE signals from the first sensor maintain similar signal strength for a predetermined time period while the vehicle is in motion.

8. The apparatus, as claimed in claim 1, wherein the processing unit is further operable to discontinue monitoring an associated sensor when the RE receiver no longer maintains similar signal strength from the associated sensor.

9. The apparatus, as claimed in claim 1, further comprising a memory operably interconnected to the processing unit, and wherein the processing unit is further operable to store an identifier of the one or more sensors that are associated with the vehicle in the memory.

10. The apparatus, as claimed in claim 9, wherein the processing unit continues monitoring the associated sensor(s) that are stored in the memory after the motion sensor no longer detects vehicle motion.

11. The apparatus, as claimed in claim 1, wherein the one or more sensor(s) are associated with at least one of a vehicle tire, vehicle hub, and vehicle axle.

12. The apparatus, as claimed in claim 11, wherein the one or more sensor(s) monitor air pressure in at least one vehicle tire associated with the sensor.

13. The apparatus, as claimed in claim 1, further comprising:
a telemetry unit operably interconnected to the processing unit and operable to communicate a status of the one or more sensors associated with the vehicle to a remote system that monitors a fleet of vehicles.

14. A method for associating a sensor with a monitor, comprising:
determining whether the monitor is in motion;
detecting radio frequency (RF) signals from one or more sensors;
monitoring characteristics of the detected RF signals;
determining that RF signals from a first sensor meet predefined characteristics when it is determined that the monitor is in motion; and
associating the first sensor with the monitor.

15. The method of claim 14, further comprising:
determining that RF signals from a second sensor meet the predefined characteristics when the monitor is in motion, the second sensor different from the first sensor; and
associating the second sensor with the monitor.

16. The method of claim 14, farther comprising:
determining that the RF signals from the first sensor no longer meet the predefined characteristics; and
disassociating the first sensor with the monitor.

17. The method of claim 14, further comprising:
storing an identification of the first sensor in a memory; and
continuing to monitor the first sensor after it is determined that the monitor is no longer in motion.

18. The method of claim 14, further comprising:
monitoring the value of an output of the first sensor; and
generating an alarm when the value is outside of a predefined range.

19. The method of claim 14, wherein the step of determining whether the monitor is in motion comprises:
monitoring an output of each axis of at least a two-axis accelerometer;
computing an average acceleration on each axis;
recording deviations from average acceleration for each axis;
monitoring the time of the deviations; and
determining that the monitor is in motion when deviations are recorded for a predetermined time period.

20. The method of claim 14, wherein the predefined characteristics comprise signal strength.

21. A system for monitoring a property of a vehicle, comprising:
at least one sensor unit associated with the vehicle, the sensor unit comprising:
a sensor that is operably interconnected with the vehicle and that outputs a value corresponding to the sensed parameter of the vehicle;
a radio frequency (RF) transmitter operably interconnected to the sensor that transmits the output of the sensor; and
a monitor, comprising:
a RF receiver that receives RF signals from the at least one sensor unit;
a processing unit operably interconnected to the RF receiver that monitors information related received RF signals from the one or more sensor units; and
a motion sensor operably interconnected to the processing unit that detects motion of the monitor;
the processing unit being operable to receive input from the motion sensor and when motion is detected, monitor the received RE signals, associate one or more sensor(s) with the monitor based on characteristics of the received RF signals, and monitor a status of the parameter monitored by each of the associated sensor(s).

22. The system, as claimed in claim 21, wherein the RF receiver receives RF signals from a plurality of sensors, and the one or more associated sensor(s) are a subset of the plurality of sensors.

23. The system, as claimed in claim 21, wherein the processing unit receives input from the motion detector indicating motion, each of the received RF signals is monitored, and a sensor is associated with the monitor when a signal is received from the respective sensor at least a predetermined number of times.

24. The system, as claimed in claim 21, wherein the processing unit is further operable to discontinue monitoring an associated sensor when the RF receiver no longer receives RF signals from the associated sensor.

25. The system, as claimed in claim 21, further comprising:
a telemetry unit operably interconnected to the monitor and operable to communicate a status of the associated sensor(s) to a remote system that monitors a fleet of vehicles.
